(19) United States
(12) Patent Application Publication
(10) Pub. No.: US 2024/0042641 A1
(43) Pub. Date: Feb. 8, 2024

(54) Mechanism For Piercing Seals And Packaging

(71) Applicant: Jessie Ceccorulli, Jacksonville, FL (US)

(72) Inventor: Jessie Ceccorulli, Jacksonville, FL (US)

(21) Appl. No.: 17/879,744

(22) Filed: Aug. 2, 2022

(51) Int. Cl. B26B 27/00

(52) U.S. Cl. CPC B26B 27/007; B65D 51/20

(57) ABSTRACT

The present disclosure provides for a piercing device for breaking through, cutting, or piercing seals and other packaging, particularly medical packaging. The piercing device may comprise a ring portion. The ring portion may comprise a sleeve or an enclosed fitting. The ring portion may comprise one or more tips and one or more openings. Each tip may comprise one or more extruded edges. The tips may be replaceable or disposable. The tips may comprise an extruded ridge to assist with opening secured containers with lids or other covers. In aspects wherein the piercing device may comprise a plurality of openings, at least one of the openings may interface with a knuckle of a human digit, such as a thumb or index finger, to increase the flexibility of the piercing device. The piercing device may comprise a material that can be sanitized and disinfected.

### CROSS-REFERENCE TO RELATED APPLICATION

This application claims priority to and the full benefit of United States Non-provisional Patent Application Ser. No. 63/228,752 (filed Aug. 3, 2021, and titled “MECHANISM FOR PIERCING SEALS AND PACKAGING”), the entire contents of which are incorporated herein by reference.

### BACKGROUND

Consumers of products, particularly medications, find relief in knowing their purchases have not been tampered with. Tamper-evident product packaging was created out of necessity after a terrifying incident involving Tylenol medicine bottles in Chicago, 1982. In the Chicago incident, a lady was poisoned after using Tylenol that had previously been criminally tampered with. Since that time, to protect user interests, medications often come in containers that are sealed with some kind of foil seal or blister cover.

The various seals and covers that have been developed for medicine containers help ensure product safety and provide an expected degree of quality. Typically made of hard or soft aluminum foil and secured with an airtight heat lacquer, medical seals and packaging protect the medication within the container before it arrives in a consumer's hands. While foil covers are beneficial to ensure product safety, they are often virtually impenetrable without a significant degree of strength or the assistance of something sharp. Although the strength of the foil covers helps ensure they are effective, the difficulty associated with opening them can be very inconvenient.

Current solutions for opening a seal include using sharp household objects that are often much larger than what is required to pierce through the seal. This may result in puncturing whatever is contained in the packaging, injuring the person trying to open the product, or cause difficulty in opening the product. For example, older people often struggle to open their prescription drug bottles. They might use scissors, a knife, or another sharp household tool to attempt to break the seal, though these tools can be dangerous for the elderly to use. Additionally, people of all ages may have physiological disorders that may increase the difficulty of using household tools for piercing the seal. For medications in particular, there is a need for these users to be able to access what is stored inside of medical packaging, which is balanced against the need to protect whatever is contained therein from potential tampering.

As an example, approximately seven million people in the United States have a tremor disorder that would make the visual-muscular coordination required to open a container seal or other types of packaging almost impossible. Using larger objects to open a seal at any age may run the additional risk of damaging the contents of a container to be opened, such as a pill bottle. Older adults may attempt to use a needle or other small household object instead, but these can be equally as cumbersome to handle and use and can be easily misplaced.

As another example, nurses need to be efficient in completing their tasks and are always on the go. Anecdotally, they often grow out one of their nails specifically so they can break the seals of blister packs and other medication seals quickly in case they don't have access to anything else to help open medication they need access to. Sharp objects, medical or otherwise, are not typically left out in the open in hospital and examination rooms, so in some instances a nurse may be required to leave a patient's side to go attempt to open medication that may need to be administered if no opening means available in close proximity.

Regardless of setting, using random sharp objects to pierce medical seals poses sanitation risks. For example, household scissors may be used to cut various materials and open mail, food packaging, and more. Using those same scissors to open a pill pack may transfer various bacteria, viruses, and other microorganisms, which may affect the quality of the medication.

### SUMMARY OF THE DISCLOSURE

There is a need for a reusable, portable, sharp piercing device that may open foil covers or other seals or packaging safely and with ease. The present disclosure provides for a piercing device for breaking through, cutting, or piercing seals and other types of medical packaging or similar sealed containers. The piercing device may provide a sanitary option for opening medical seals and packaging. The piercing device may assist the elderly and physical impaired and allow those individuals to have more independence by being able to open their own medications with the assistance of the piercing device.

In some aspects, the piercing device may comprise a substantially cylindrical ring portion. In some embodiments, the ring portion may at least partially comprise a sleeve or an enclosed fitting. In some implementations, the ring portion may comprise one or more tips and one or more openings. Each of the one or more tips may comprise one or more extruded edges, ridges, or similar structures. In some aspects, each tip may be replaceable or disposable. In some embodiments, the piercing device may comprise one or more openings to interface with each of the removable tips.

In some embodiments, each tip may comprise at least one extruded edge or ridge to assist in opening secured containers with lids, covers, or other seals. When the piercing device comprises one or more openings, at least one of the openings may interface with a knuckle of a human digit, such as a thumb or index finger, to increase the flexibility of the piercing device. In some aspects, the piercing device may comprise a material that may be sanitized and disinfected.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary piercing device, according to some embodiments in the present disclosure.

FIG. 1B illustrates an exemplary piercing device, according to some embodiments in the present disclosure.

FIG. 1C illustrates an exemplary piercing device, according to some embodiments in the present disclosure.

FIG. 2A illustrates an exemplary piercing device, according to some embodiments in the present disclosure.

FIG. 2B illustrates an exemplary piercing device, according to some embodiments in the present disclosure.

FIG. 3A illustrates an exemplary tip, according to some embodiments in the present disclosure.

FIG. 3B illustrates an exemplary tip, according to some embodiments in the present disclosure.

FIG. 3C illustrates an exemplary tip, according to some embodiments in the present disclosure.

FIG. 3D illustrates an exemplary tip, according to some embodiments in the present disclosure.

FIG. 4A illustrates an exemplary piercing device comprising one or more tips, according to some embodiments in the present disclosure.

FIG. 4B illustrates an exemplary piercing device comprising one or more tips, according to some embodiments in the present disclosure.

FIG. 4C illustrates an exemplary piercing device comprising one or more tips, according to some embodiments in the present disclosure.

FIG. 4D illustrates an exemplary piercing device comprising one or more tips, according to some embodiments in the present disclosure.

FIG. 5 illustrates an exemplary piercing device, according to some embodiments in the present disclosure.

FIG. 6A illustrates an exemplary piercing device, according to some embodiments in the present disclosure.

FIG. 6B illustrates an exemplary piercing device, according to some embodiments in the present disclosure.

FIG. 6C illustrates an exemplary piercing device, according to some embodiments in the present disclosure.

FIG. 7A illustrates an exemplary piercing device comprising an attachment mechanism, according to some embodiments in the present disclosure.

FIG. 7B illustrates an exemplary piercing device comprising an attachment mechanism, according to some embodiments in the present disclosure.

FIG. 8A illustrates an exemplary storage device, according to some embodiments in the present disclosure.

FIG. 8B illustrates an exemplary storage device, according to some embodiments in the present disclosure.

FIG. 9A illustrates an exemplary piercing device comprising a tip, according to some embodiments in the present disclosure.

FIG. 9B illustrates an exemplary piercing device comprising a tip, according to some embodiments in the present disclosure.

FIG. 9C illustrates an exemplary piercing device comprising a tip, according to some embodiments in the present disclosure.

FIG. 9D illustrates an exemplary piercing device comprising a tip, according to some embodiments in the present disclosure.

FIG. 9E illustrates an exemplary piercing device comprising a tip, according to some embodiments in the present disclosure.

FIG. 10 illustrates an exemplary piercing device, according to some embodiments in the present disclosure.

FIG. 11 illustrates an exemplary piercing device, according to some embodiments in the present disclosure.

FIG. 12A illustrates an exemplary piercing device comprising a tip, according to some embodiments in the present disclosure.

FIG. 12B illustrates an exemplary piercing device comprising a tip, according to some embodiments in the present disclosure.

### DETAILED DESCRIPTION

The present disclosure provides generally for a piercing device for breaking through, cutting, or piercing seals and other packaging, particularly medical packaging. The piercing device may provide a sanitary option for opening medical seals and packaging. The piercing device may assist the elderly and physically impaired to have more independence by opening their own medications with the assistance of the piercing device.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Ring portion: as used herein, refers to the cylindrical body of the piercing device. The ring portion may comprise at least one sidewall and a substantially open bottom region. Additionally, the ring portion may comprise one or more flexible materials so the ring portion may slide onto a human digit or other object of similar size and shape, such as a pencil, pen, or permanent marker, though these are non-limiting examples. The ring portion may have a fixed or adjustable circumference or diameter so that the ring portion may accommodate human digits or other cylindrical objects of varying circumferences or diameters. The ring portion may include one or more openings fixed into a portion its sidewall(s) to further improve its flexibility. In some embodiments, the ring portion may comprise at least one attachment mechanism, such as, by way of example and not limitation, a hook, pin, clamp, snapping mechanism, magnet, hook-and-loop fastener, or clasp, allowing the ring portion to be connected to a lanyard, keychain, or other common items.
Storage device: as used herein, refers to an external device that houses the piercing device when it is not in use. In some embodiments, the storage device may comprise a storage body, a top, a hinge that allows the top to open, and a locking mechanism. In some implementations, the storage device may comprise a body and a removable top that may snap or button into place, as non-limiting examples. In some aspects, the piercing device may be inserted into an internal mold within the storage device for secure storing. In some implementations, the internal mold may accommodate the entire assembled piercing device or have designated insertion points for the ring portion and the tip, so long as they are separable. The storage device may comprise an internal sanitizing mechanism or system, such as, but not limited to, one or more ultraviolet lights, to at least partially clean, sanitize, disinfect, or sterilize the piercing device when it is inserted into the storage device. In some aspects, the storage device may comprise one or more sensors and associated sensor lighting elements that may alert a user when a sanitation cycle or process is completed. The storage device may comprise at least one attachment mechanism, such as, by way of example and not limitation, a hook, pin, clamp, snapping mechanism, magnet, hook-and-loop fastener, or clasp, allowing the storage device to be connected to a lanyard, keychain, or other common items.
Tip: as used herein, refers to a protruded appendage coupled to the ring portion. In some embodiments, the tip may have one or more sharp edges, ridges, or similar structures that may be used for piercing, penetrating, tearing, or similar functions that may be useful when opening a seal, lid, cover, or other packaging materials or components. In some embodiments, the tip may be configured in a fixed position on the ring portion. In some aspects, the tip may be removable from its position on the ring portion, so that the tip may be replaced if dull or removed for either storing, sanitizing, or both. In some implementations, the tip may comprise one or more teeth, a serrated edge, or any other sharp or protruding edge or similar structure, though these are non-limiting examples.

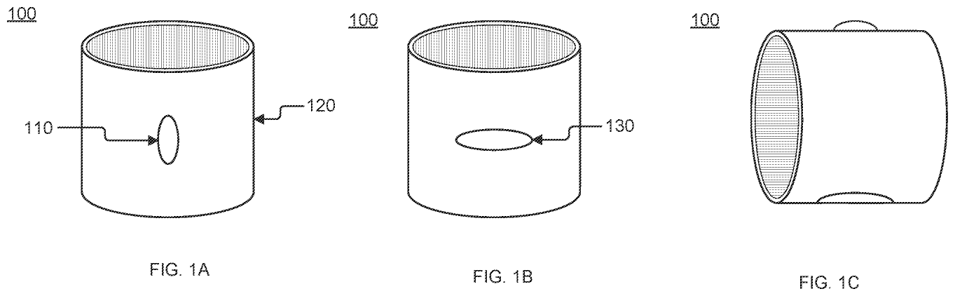

Referring now to FIGS. 1A-C, an exemplary piercing device 100 is illustrated. In some embodiments, the piercing device 100 may comprise a ring portion 120. In some implementations, the ring portion 120 may comprise one or more tips 110 protruding outwardly from at least one sidewall of the ring portion 120. In some aspects, the ring portion 120 may comprise at least one opening 130 within the at least one sidewall of the ring portion 120 to improve the flexibility of the piercing device 100.

In some embodiments, the ring portion 120 may comprise a substantially open bottom region configured to removably receive a human digit or object of similar shape and size. In some aspects, the ring portion 120 may be at least partially flexible so that the piercing device 100 may be worn on a human digit, such as a thumb or index finger, with at least some amount of retaining force being applied to the human digit by the ring portion 120. In some implementations, the ring portion 120 may comprise silicone or some other flexible and easily cleaned material. In some embodiments, the ring portion 120 may completely encircle the human digit upon which the ring portion 120 may be worn. In some aspects, the piercing device 100 may comprise at least one opening 130 at a position within at least one sidewall of the ring portion 120 that aligns with a knuckle of a human digit. The opening 130 may be ovular, circular, or shaped in some other way that enhances flexibility and fits comfortably over a human knuckle when worn.

In some aspects, a plurality of tips 110 may be located on an exterior face of the ring portion 120 at some position on a side portion of the piercing device 100 such that the plurality of tips 110 aligns with the underside of a knuckle of a human digit upon which the piercing device 100 may be worn and points away from the digit wearing the piercing device 100. In some embodiments, the plurality of tips 110 may comprise one or more tips of uniform or varying size, shape, and material. In some aspects, each tip 110 may comprise a sharp edge, ridge, or similar structure that may be used to poke through, pierce, or slice a seal or other kind of packaging, such as a blister pack.

In some aspects, the piercing device 100 may be configured to facilitate the opening of medical seals and packaging while maintaining a sanitary extraction of the packaged substance. In some embodiments, each tip 110 may be configured so as to be able to apply a sufficient amount of force to a seal or packaging to form a tear in the material while remaining sufficiently blunt to avoid injury to a user while using the piercing device 100. In some aspects, the piercing device 100 may comprise one or more materials that allow the piercing device to be reusable, such as, by way of example and not limitation, one or more metals, plastics, other polymers, or similar elements or combinations thereof.

In some implementations, the ring portion 120 of the piercing device 100 may provide sufficient stability to assist in placing enough intentional force on the a or packaging to form a perforation. For example, an elderly individual with a minor tremor in their hands may find it difficult to open the medical packaging for prescribed medication, notwithstanding the use of an external tool such as scissors, due to the tremor or age-induced inability to apply sufficient force in a singular location to open the packaging.

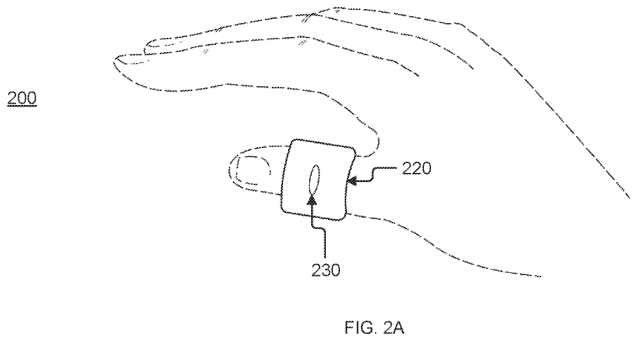

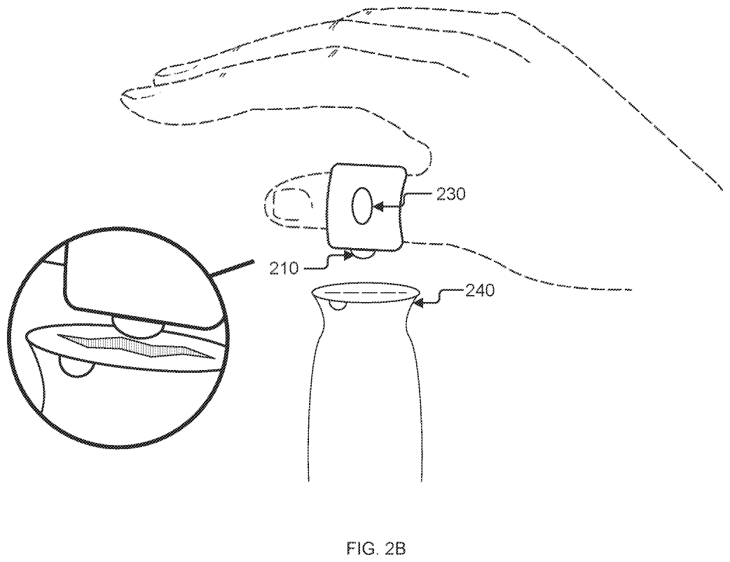

Referring now to FIGS. 2A-B, an exemplary piercing device 200 is illustrated. In some embodiments, the piercing device 200 may comprise a ring portion 220. In some implementations, the ring portion 220 may comprise at least one sidewall that comprises at least one opening 230. In some aspects, the ring portion 220 may comprise at least one tip 210. In some embodiments, the tip 210 may interface with a sealed surface 240.

For example, the tip 210 may pierce, slice, poke through, or tear a sealed surface 240. In some embodiments, the tip 210 may allow for the sterilization of the portion of the piercing device 200 that may interface with the contents of a container that includes sealed surface 240. The tip 210 may be useful in maintaining sanitation in hygienic environments such as hospitals and health clinics. In some embodiments, the contours of the tip 210 may comprise a variable surface to assist in opening a plurality of different types of seals and packaging. In some aspects, the sealed surface 240 may comprise a hard or soft aluminum foil, or some other similar element or combination of elements, and may be sealed to a container in an airtight manner via a heat-sealing lacquer, as a non-limiting example.

In some embodiments, the ring portion 220 may comprise a substantially hollow cylinder or be able to be folded or shaped into a hollow cylinder to be worn on a human digit. The ring portion 220 may at least partially comprise a flexible material to accommodate human digits of varying shapes and sizes across a broad spectrum of users. In some implementations, the circumference or diameter of the ring portion 220 may be adjusted by an individual user to fit different digits on their hand. In some aspects, the piercing device 200 may be specifically orientated for right-handedness or left-handedness.

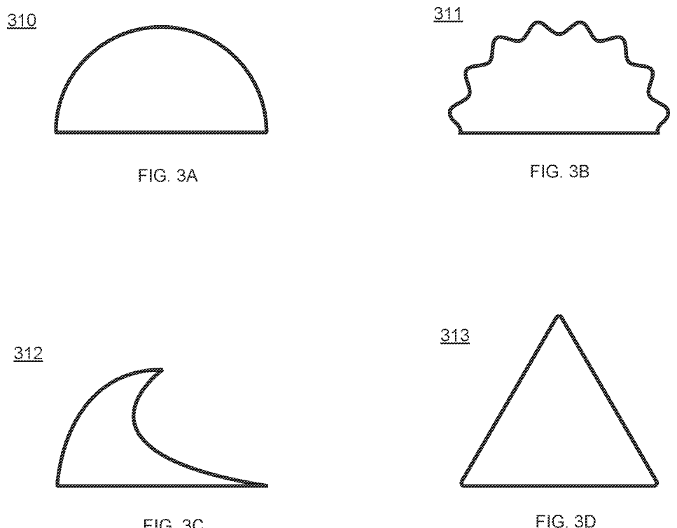

Referring now to FIGS. 3A-D, an exemplary tip 310, 311, 312, 313 is illustrated. In some embodiments, the tip 310, 311, 312, 313 may comprise a plurality of different sizes, shapes, edges, and materials. For example, the tip 310 may be configured with a relatively blunt or rounded shape that may make it appropriate for opening seals that require a relatively low amount of force to be punctured, pierced, or otherwise opened. The tip 311 may be used on a variety of seals, from seals that require larger puncture forces to open to seals that are extremely small and require a pinpoint focused amount of pressure to break through. A plurality of ridges along the surface of the tip 311 may provide a serrated characteristic to the tip 311, thereby providing an alternative method for piercing and opening seals and packaging.

The tip 312 may also be used on seals that require a pinpoint amount of pressure to break through. In some aspects, the tip 312 may comprise an elongated end that may operate as a lever to open lids. As an illustrative example, a geriatric patient in a nursing facility may struggle to complete the two-phase motion of rotation and applied pressure necessary to open a prescription bottle. The tip 312 may allow the geriatric patient to apply force to the bottom lip of the lid to assist with pulling off the lid as the lid is rotated. This may simplify complex motions for individuals with motive or strength inhibitions that otherwise may not be able to open medical seals, packaging, or container lids, as non-limiting examples.

In some implementations, the tip 313 may be used and rotated within the piercing device 300 about at least one axis, so that when one end becomes dull, it may be replaced without entirely replacing the tip 313. In some aspects, the tip 313 may comprise a plurality of different contours on each edge to allow for selection of a desired tip 313 contour.

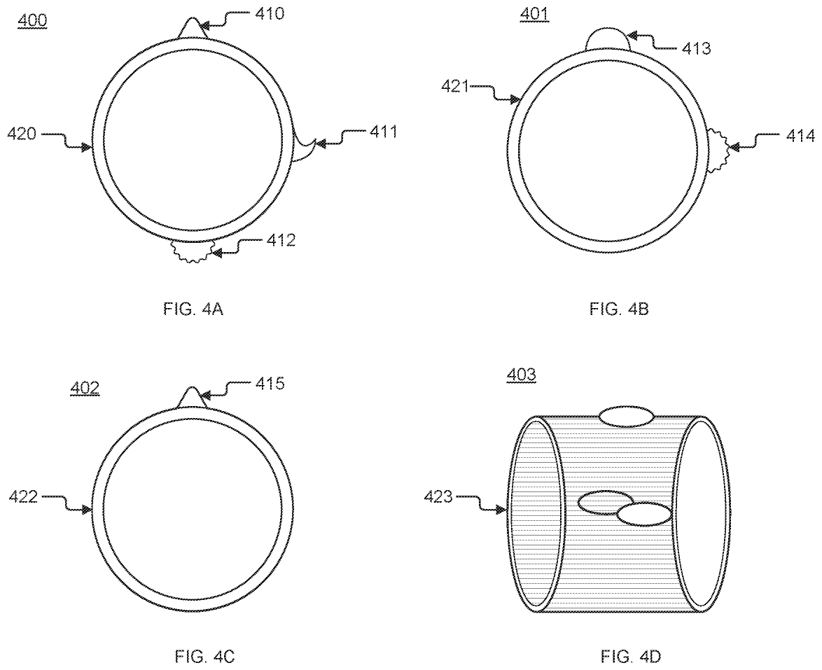

Referring now to FIGS. 4A-D, an exemplary piercing device 400, 401, 402, 403 comprising one or more tips 410, 411, 412, 413, 414, 415 is illustrated. In some embodiments, the piercing device 400, 401, 402, 403 may comprise a ring portion 420, 421, 422, 423. In some implementations, the ring portion 420, 421, 422, 423 may comprise one or more tips 410, 411, 412, 413, 414, 415.

For example, the piercing device 400 may comprise a plurality of tips 410, 411, 412 arranged at various positions along the perimeter of an exterior sidewall of the ring portion 420. The tips 410, 411, 412 may be uniform or varied, comprising different sizes, shapes, sharpnesses, or other non-limiting characteristics. A piercing device 400 comprising a plurality of tips 410, 411, 412 may increase the utility of the piercing device 400. For example, the piercing device 400 may comprise an extruded point as a tip 410 for puncturing seals, a serrated tip 412 for opening packaging, and a hooked tip 411 to assist in opening capped containers.

The positions of the tips 410, 411, 412 may be fixed on an exterior face of the ring portion 420 or the positions of the tips 410, 411, 412 may be adjustable. Adequate spacing may be fixed between tips 410, 411, 412 to allow for use of a tip 410, 411, 412 without interference from another tip 410, 411, 412. In some embodiments, the tips 410, 411, 412 may be interchangeable with one another and with other tips, so that a user may customize the piercing device 400.

In some implementations, the piercing device 401 may comprise a blunt tip 413 and a jagged, sharp tip 414. This may allow the piercing device to open more than one kind of seal with ease. In some embodiments, the piercing device 401 may comprise a plurality of tips 413, 414 oriented on the piercing device 401 based on the frequency of use of the tips 413, 414. For example, the puncturing tip 413 may reside at the front of the piercing device 401 because it may be used most frequently. In some aspects, the piercing device 402 may comprise one tip 415 that may be interchangeable within the exterior face of at least one sidewall of the ring portion 422. In some embodiments, the tip 415 may be sharpened by an external device when it becomes dull after use.

In some aspects, the piercing device 403 may comprise several tips that may not be in a fixed position within the exterior face of at least one sidewall of the ring portion 423. In some embodiments, the sidewall of ring portion 423 may comprise an at least partially magnetic material that may allow the sidewall of the ring portion 423 to interface with one or more magnetic tips. This may allow the tips to be removed and attached easily to be replaced or rearranged, as non-limiting options. For example, in a sterile environment, the tips may be designed for single-use and may be disposed upon completed use.

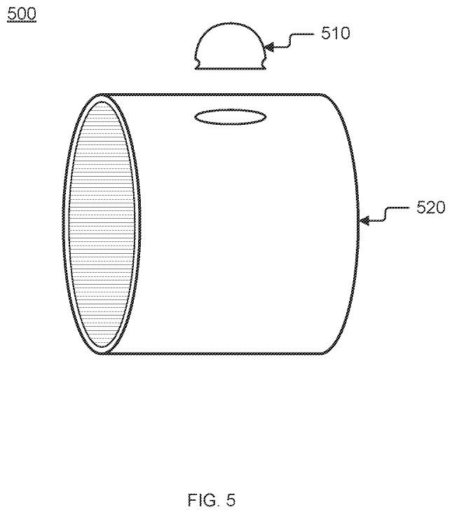

Referring now to FIG. 5, an exemplary piercing device 500 is illustrated. In some embodiments, the piercing device 500 may comprise a ring portion 520. In some implementations, the ring portion 520 may comprise at least one tip 510. In some aspects, the tip 510 may be removable.

In some embodiments, the tip 510 may be interchangeable with other tips. The tip 510 may be insertable into a hole within the exterior face of at least one sidewall of the ring portion 520. In some implementations, the tip 510 may be couplable to the exterior face of the sidewall of the ring portion 520, such as, by way of example and not limitation, via a magnetic connection. This may allow the tip 510 to be removed and attached easily in order to be replaced or rearranged, as non-limiting options. For example, in a sterile environment, the tip 510 may be designed for single-use and may be disposed after completed use. In some aspects, the tip 510 may be replaced as the contours of the tip 510 wear away, thereby reducing its effectiveness.

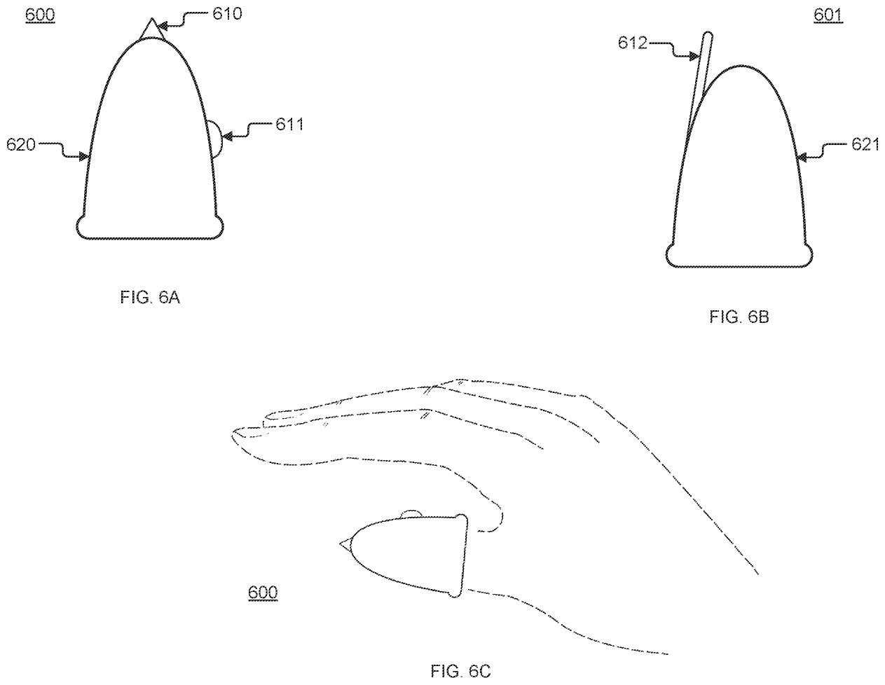

Referring now to FIGS. 6A-C, an exemplary piercing device 600, 601 is illustrated. In some embodiments, the piercing device 600, 601 may comprise a ring portion 620, 621. In some implementations, the ring portion 620, 621 may comprise one or more tips 610, 611, 612.

In some aspects, the piercing device 600, 601 may cover the top of a human digit upon the which the piercing device 600, 601 may be worn For example, the ring portion 620, 621 may comprise an extension in the form of an integrated cap that extends from a top region of the ring portion 620, 621 to cover and protect the top portion of the human digit when the piercing device 600, 601 is worn and/or in use. The piercing device 600, 601 may comprise a plurality of tips 610, 611 that may be fixed or adjustable at designated or customizable positions within the exterior face of at least one sidewall of the piercing device 600, 601. A plurality of predetermined locations for tips 610, 611 may allow for a more intuitive usage of the piercing device 600, 601. For example, nurses that may traditionally use a fingernail to pull up a corner of medical packaging after puncturing a seal may instead use a tip 612 to mimic the same motion after piercing the packaging with a second tip 611.

In some embodiments, the entirety of the tip 612 may be wholly or partially exposed when coupled to the piercing device 601. In some implementations, a wholly exposed tip 612 may allow the tip 612 to pierce or penetrate a seal, cover, or other form of packaging to a greater depth. In some aspects, a wholly exposed tip 612 may provide sufficient length to allow for easy maneuverability and tactile manipulation of a seal or other packaging.

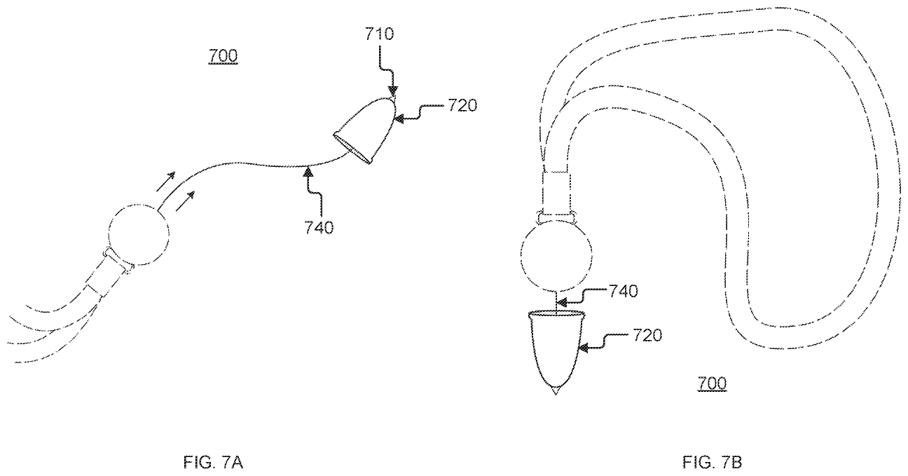

Referring now to FIGS. 7A-B, an exemplary piercing device 700 comprising an attachment mechanism 740 is illustrated. In some embodiments, the piercing device 700 may comprise a ring portion 720. For example, the piercing device 700 may be worn on a human digit or attached to an external device, such as a lanyard, via an attachment mechanism 740. In some embodiments, the attachment mechanism 740 may be extendable and retractable to allow a user to keep the lanyard around their neck when they want to use the piercing device 700. The attachment mechanism 740 may comprise at least one securing mechanism, such as, by way of example and not limitation, a hook, pin, clamp, snapping mechanism, magnet, hook-and-loop fastener, or clasp to secure the piercing device 700 in place on the lanyard when not in use.

Removed accessibility via an attachment mechanism 740 may allow the piercing device 700 to remain removed from possible contamination and unintentional wear while remaining easily accessible. In some embodiments, the attachment mechanism 740 may allow the piercing device 700 to be used without being worn by the user and be used as an external tool by the user.

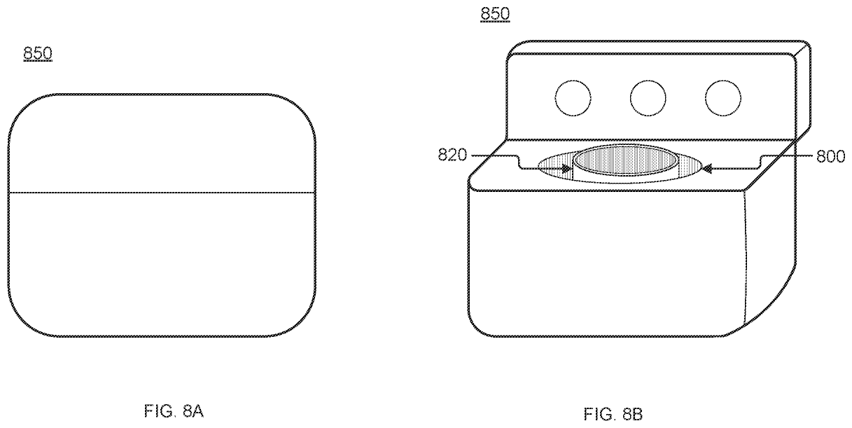

Referring now to FIGS. 8A-B, an exemplary storage device 850 is illustrated. In some embodiments, the storage device 850 may be configured to retain a piercing device 800 therein. In some implementations, the circumference of the ring portion 820 of the piercing device 800 may be smaller than the interior diameter of the storage device 850.

In some embodiments, the storage device 850 may comprise an interior mold that fits securely around the piercing device 800 when the piercing device 800 may be inserted therein. In some aspects, the storage device 850 may comprise an interior cleaning system that may at least partially clean, disinfect, sanitize, or sterilize the piercing device 800 when the piercing device 800 may be inserted therein. In some implementations, there may be one or more external lighting elements fixed on the storage device 850 that may indicate when a sanitization process is complete.

In some implementations, the interior cleaning system may comprise one or more ultraviolet or infrared lights, as non-limiting examples, that may be configured to at least partially disinfect, sanitize, or sterilize the piercing device 800 when the piercing device 800 may be inserted into the storage device 850. In some aspects, the storage device 850 may at least partially comprise a thermoregulating material, so that the storage device 850 may be prevented from overheating during a sanitization process. In some embodiments, the storage device 850 may comprise an external attachment mechanism, such as, by way of example and not limitation, a hook, pin, clamp, snapping mechanism, magnet, hook-and-loop fastener, or clasp that allows the storage device 850 to be coupled to an external device, such as a lanyard, key ring, workbag, backpack, and other non-limiting examples. In some implementations, the storage device 850 may be sufficiently small so as to be portable. In some aspects, a portable storage device 850 may contain the piercing device 800 for protection or safekeeping during daily use.

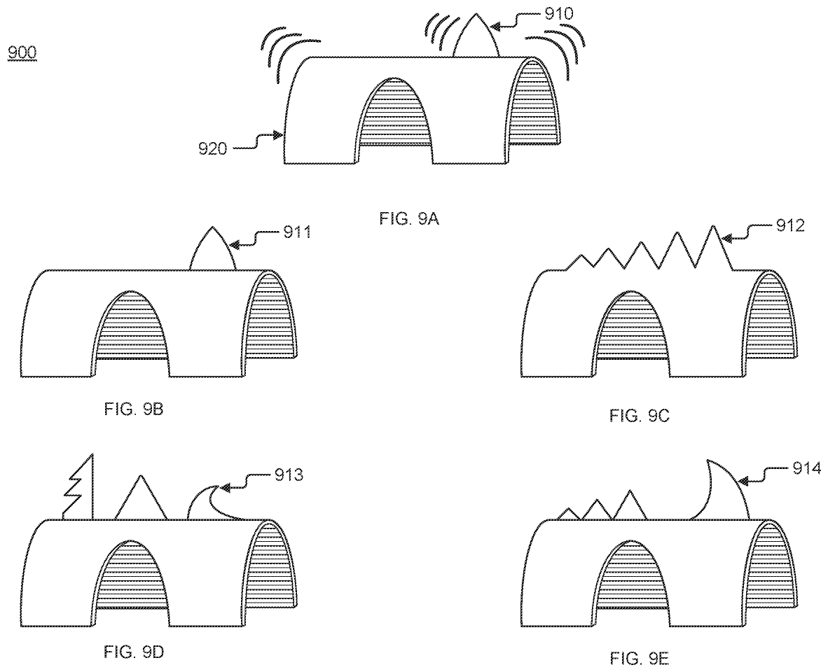

Referring now to FIGS. 9A-E, an exemplary piercing device 900 comprising at least one tip 910, 911, 912, 913, 914 is illustrated. In some embodiments, the piercing device 900 may comprise one or more electrical components. In some implementations, the electrical components may supply power via, for example and not limitation, one or more conducting wires to the piercing device 900 from, such as, by way of example and not limitation, at least one battery, at least one solar cell or similar photovoltaic element, or any similar appropriate power source.

In some aspects, the piercing device 900 may comprise one or more devices or mechanisms that may cause the piercing device 900 to move in a way that may facilitate easier opening of sealed surfaces. For example, the electrical components of piercing device 900 may provide enough power to allow a vibrating device within at least one portion of the piercing device 900 to cause the piercing device 900 and/or tip 910 to vibrate at a sufficient rate or frequency to enable the tip 910 of the piercing device 900 to penetrate the top of a sealed medicine bottle or other similar packaging.

In some embodiments, the electrical components of piercing device 900 may at least partially comprise at least one gyroscope. In some implementations, the gyroscope may measure existing vibrations and movements in a user's hand and/or one or more digits. As an illustrative example, the gyroscope may measure vibrations in the user's hand or digit(s) and may match the range and frequency of an involuntary tremor associated with the hand or digit(s) The electrical components may then create or induce one or more vibrations in the piercing device 900 (or one or more portions thereof, such as, by way of example and not limitation, the tip 910) of the same frequency to counteract the tremor associated with the hand or digit(s) and provide stability when using the piercing device 900.

In some embodiments, the tip 912 may comprise two or more edges, ridges, or similar structures. In some implementations, the edges may form a serrated edge that may improve the ability of piercing device 900 to penetrate a sealed surface. In some aspects, the two or more edges of the tip 913, 914 may provide different edges for different functions. For example, one edge may be long and thin for penetration purposes and another edge may form a blunt shape that can be used to apply force to medicine lids to make them easier to open.

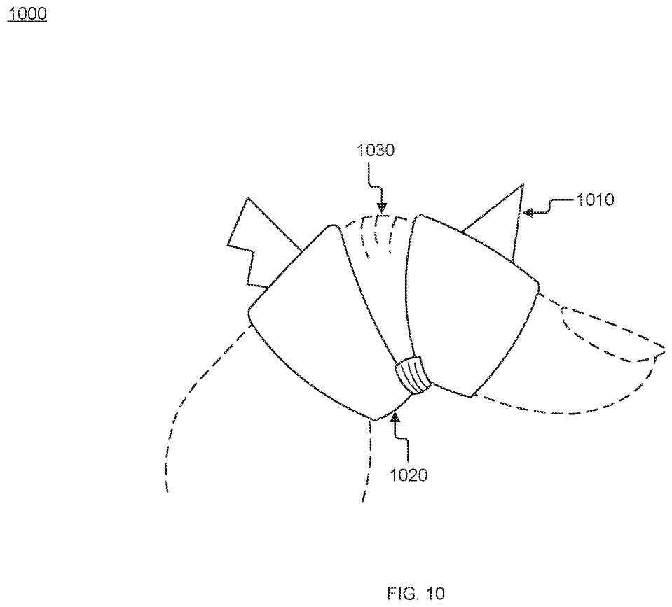

Referring now to FIG. 10, an exemplary piercing device 1000 is illustrated. In some embodiments, the piercing device 1000 may comprise at least one opening 1030. In some implementations, the piercing device 1000 may comprise at least one tip 1010. In some aspects, the piercing device 1000 may comprise a ring portion 1020. In some embodiments, the ring portion 1020 may comprise the at least one opening 1030.

In some implementations, the opening 1030 may facilitate an increased range of motion for a user wearing piercing device 1000. For example, the opening 1030 may be configured at, proximate, or near a natural flexion point of a user, such as a knuckle or joint on a thumb. In some embodiments, the piercing device 1000 may include at least one hinge to increase its flexibility. By way of example and not limitation, the at least one hinge may be configured at, proximate, or near a natural flexion point of a user, such as a knuckle or joint on a thumb. In some aspects, the opening 1030 may separate two or more edges of a tip 1010.

In some embodiments, the two or more edges of the tip 1010 may provide different edges for different functions. For example, one edge may be long and thin for penetration purposes and another edge may form a blunt shape that can be used to apply force to medicine lids to make them easier to open. In some implementations, the ring portion 1020 may comprise at least one opening 1030. In some aspects, the opening 1030 may improve the comfort of a user wearing the piercing device 1000.

As an illustrative example, the ring portion 1020 may comprise two parts that are joined by an at least partially flexible portion. The piercing device 1000 may be worn on the thumb of a user and, when the thumb is bent, the two parts of the ring portion may separate to match the dexterity of the thumb.

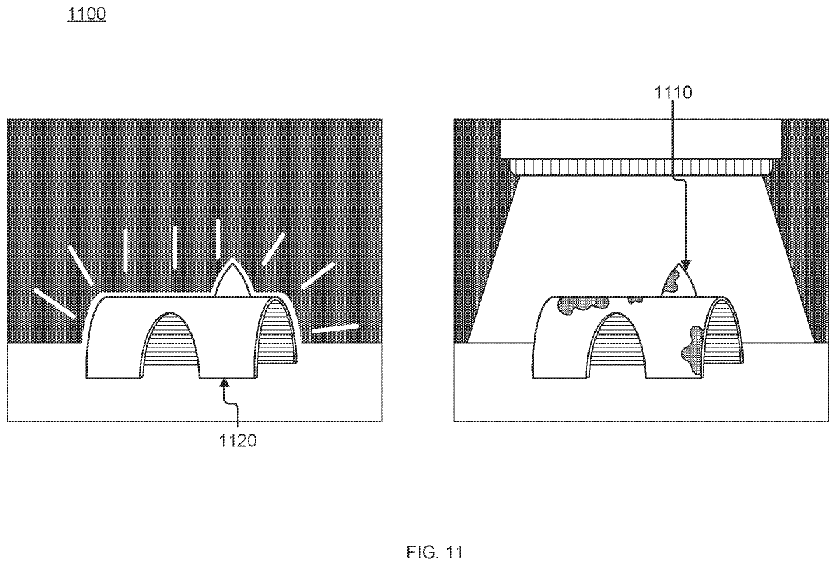

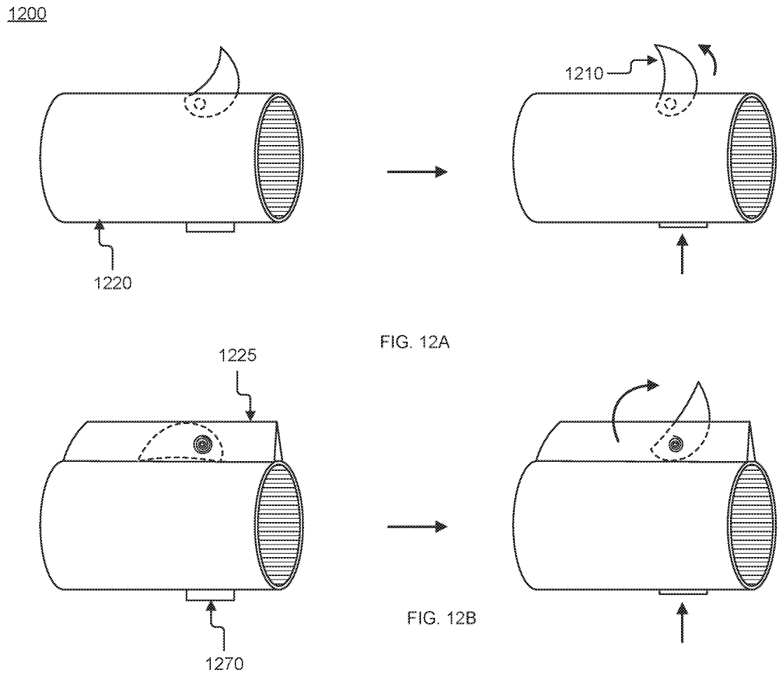

Referring now to FIG. 11, an exemplary piercing device 1100 is illustrated. In some embodiments, the piercing device 1100 may comprise a ring portion 1120. In some implementations, the piercing device may comprise at least one tip 1110.

In some implementations, one or more portions of piercing device 1100, such as, by way of example and not limitation, tip 1110 and/or ring portion 1120, may at least partially comprise a phosphorescent or similar luminescent material, coating, or paint that may facilitate the ability of a user to see the one or more portions of piercing device 1100 and use it to open a seal, lid, cover, or other packaging under conditions when lighting is reduced.

In some aspects, piercing device 1100 may at least partially comprise one or more materials that, when placed in proximity to one or more sources of ultraviolet light, allows the piercing device 1100 to be at least partially cleaned, sanitized, disinfected, or sterilized. Sterilization may be particularly important when piercing device 1100 is used in medical settings, such as clinics or hospitals.

Referring now to FIGS. 12A-B, an exemplary piercing device 1200 comprising a tip 1210 is illustrated. In some embodiments, the piercing device 1200 may comprise at least one tip 1210. In some implementations, the piercing device 1200 may comprise a ring portion 1220. In some aspects, the ring portion 1220 may comprise at least one housing 1225. In some embodiments, the piercing device 1200 may comprise at least one release mechanism 1270.

In some implementations, tip 1210 may be configured to alternate between a first position and a second position, wherein the first position comprises a stored or retracted position for tip 1210 and the second position may comprise a deployed, exposed, or extended position for tip 1210.

In some embodiments, by way of example and not limitation, tip 1210 may be configured to alternate between the first and second position by rotating about at least one axis or by sliding within one or more channels, grooves, recesses, indentations, or tracks. In some aspects, one or more spring mechanisms may facilitate the movement of tip 1210 from the first position to the second position.

In some implementations, tip 1210 may be secured, locked, or restrained when in the first position, such as, for example and not limitation, by at least one physical protruding element. In some aspects, one or more release mechanisms 1270 may need to be engaged in order to release tip 1210 from the first position.

By way of example and not limitation, the release mechanism 1270 may comprise a button, lever, or switch configured to move the at least one protruding element such that the protruding element no longer restrains tip 1210 the tip 1210 is free to move to the second position. In some embodiments, tip 1210 may be secured in the second position so that it may remain in the second position while experiencing one or more forces associated with penetrating a seal, opening one or more types of packaging materials (e.g., piercing or tearing through a piece of tape), or otherwise opening a container that comprises a cover or lid.

As an example, tip 1210 may be secured in the second position by removably snapping into place via the interaction of two or more separable interlocking parts, such as one or more protruding tabs, ridges, or detents interacting with one or more notches, grooves, or recesses. In some aspects, a user may release tip 1210 from the second position by applying an amount of force sufficient to overcome the resistance of the interlocking parts that form the snap-fit.

In some implementations, tip 1210 may be at least partially contained within at least one housing 1225 when in the first position. Housing 1225 may protect tip 1210 from damage while in the first position and may prevent a user from being injured by tip 1210 or from inadvertently injuring others with tip 1210 when tip 1210 is in the first position.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A piercing device comprising:
a ring portion, wherein the ring portion comprises a substantially hollow cylindrical body, at least one sidewall, and a substantially open bottom region configured to removably receive a human digit; and
at least one tip, wherein the at least one tip protrudes outwardly from the at least one sidewall of the ring portion.

2. The piercing device of claim 1, wherein the ring portion comprises a circumference and a diameter that are adjustable.

3. The piercing device of claim 1, wherein the ring portion completely encircles the human digit when the human digit is received by the ring portion.

4. The piercing device of claim 1, wherein the ring portion comprises at least one opening in the at least one sidewall.

5. The piercing device of claim 4, wherein the at least one opening is configured to be proximate to a knuckle of the human digit when the human digit is received by the ring portion.

6. The piercing device of claim 1, wherein the at least one tip is removable.

7. The piercing device of claim 1, wherein the ring portion comprises an integrated cap that extends from a top region of the ring portion, wherein the cap is configured to cover a top portion of the human digit when the human digit is received by the ring portion.

8. The piercing device of claim 1, wherein the ring portion comprises two or more of the at least one tip.

9. The piercing device of claim 1, wherein the at least one tip is alterable between a first position and a second position, wherein the first position comprises a retracted position and the second position comprises an extended position.

10. The piercing device of claim 9, wherein the at least one tip is configured to alternate between the first position and the second position by rotating about at least one axis.

11. The piercing device of claim 9, wherein the at least one tip is at least partially contained within at least one housing when in the first position.

12. The piercing device of claim 1, wherein the ring portion comprises at least one electrical component.

13. The piercing device of claim 12, wherein the at least one electrical component causes the at least one tip to vibrate.

14. The piercing device of claim 12, wherein the at least one electrical component creates one or more vibrations in the piercing device that counteract a tremor of the human digit when the human digit is received by the ring portion, thereby stabilizing the piercing device during use.

15. A piercing device comprising:
a ring portion, wherein the ring portion comprises a substantially hollow cylindrical body with at least one sidewall and a substantially open bottom region configured to removably receive a human digit; and
a plurality of tips, wherein each of the plurality of tips protrudes outwardly from the at least one sidewall of the ring portion.

16. The piercing device of claim 15, wherein each of the plurality of tips is removable.

17. The piercing device of claim 15, wherein the ring portion comprises an integrated cap that extends from a top region of the ring portion, wherein the cap is configured to cover a top portion of the human digit when the human digit is received by the ring portion.

18. The piercing device of claim 15, wherein the ring portion comprises at least one electrical component.

19. The piercing device of claim 18, wherein the at least one electrical component causes at least one of the plurality of tips to vibrate.

20. The piercing device of claim 18, wherein the at least one electrical component creates one or more vibrations in the piercing device that counteract a tremor of the human digit when the human digit is received by the ring portion, thereby stabilizing the piercing device during use.
